(19) United States
(12) Patent Application Publication
(10) Pub. No.: US 2009/0039916 A1
(43) Pub. Date: Feb. 12, 2009

(54) Systems and Apparatus for Providing a Multi-Mode Memory Interface

(75) Inventors: Peter Buchmann, Wald (CH); Christian I. Menolfi, Langnau am Albis (CH); Martin L. Schmatz, Rueschlikon (CH); Thomas H. Toifl, Zurich (CH); Jonas R. Weiss, Zurich (CH)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/834,926

(22) Filed: Aug. 7, 2007

(51) Int. Cl. G06F 7/38

(52) U.S. Cl. 326/38

(57) ABSTRACT

An integrated circuit for a memory input/output (I/O) pin has five different modes of operation. The memory chip is enabled to operate with unbuffered (or registered) dual inline memory modules (DIMMs) as well as fully buffered DIMMs. A T-coil circuit equalizes the capacitive loading of the high-speed functions. An exemplary embodiment provides a memory chip containing a multi-functional physical I/O circuit that can act as power or ground; as a DDR2 or DDR3 interface; as a high-speed differential receiver; or as a high-speed differential transmitter.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

### Technical Field

The present invention relates to methods and apparatus for providing multi-functional operational modes to memory input/output (I/O) pins in an integrated circuit chip.

Integrated circuit memory devices are evolving in ever-greater complexity. As these memory devices evolve, often times the terminal pins that connect the memory device to the digital bus systems that carry their signals must change as well. This often results in memory devices that are not backward or forward compatible. The changes to the terminal pins also result in digital buses that are also not forward or backward compatible. Furthermore, IO pins often should be capable of supporting multiple standards, requiring multiple functionality of a pin. As memory devices evolve, there is a change of single ended, wide digital buses to narrow high-speed “serial like” bus attachments for memory devices. Some microprocessors have applicability in both areas (‘traditional’ buses and high-speed serial buses). Therefore, there exists a need for memory devices that can handle both I/O principles.

There exists a need for a memory device having terminal pins with multifunctional capability for allowing the memory device to be both backward and forward compatible. There also exists a need for a memory device that is operable with both dual inline memory modules (DIMMs) and fully buffered DIMMs. Therefore, a physical I/O circuit is needed that has a mode selection that can (1) act as power or ground; (2) act as a DDR2 or DDR3 (double data rate two or three) interface; (3) act as a high-speed differential receiver pin pair; and/or (4) act as a high-speed differential transmitter pin pair.

There also exists a need to provide a memory device that enables the mode selection to be carried out with fewer pins dedicated to that selection.

### SUMMARY

The embodiments disclosed herein provide an integrated circuit and system having one or multiple modes of operation. The integrated circuit comprises a pair of terminal input/output pins and a pair of T-coil circuits. Each pin is connected to a node of an individual T-coil circuit, wherein the individual T-coil circuit comprises a pair of serially connected coupled inductors and a bridging capacitor forming three nodes, wherein at least one node is connected to the terminal input/output pin, a middle tap is connected to a capacitive load, and a third node is connected to a resistive load. The capacitive load comprises an electrostatic discharge diode and a plurality of thick-oxide switches connecting at least one of a power or ground; a DDR2 or DDR3 data interface; and a high-speed differential receiver circuit. The resistive load comprises a plurality of thick-oxide switches connecting a high-speed differential driver, wherein the plurality of thick-oxide switches are used to select the mode of operation of the integrated circuit, and wherein the T-coil circuit is used to compensate parasitic capacitances that occur once the power, ground, or DDR2/DDR3 interface is disabled.

### BRIEF DESCRIPTION OF DRAWINGS

Referring now to the drawings wherein like elements are numbered alike in the several FIGURES:

FIG. 1 illustrates an exemplary embodiment of a multi-functional memory I/O pin having transmit/receive functionality;

FIG. 2 illustrates an exemplary embodiment of a T-Coil structure;

FIG. 3a illustrates an exemplary embodiment of a multi-functional memory I/O pin having functionality of a DDR2 or DDR3 interface;

FIG. 3b illustrates an exemplary embodiment of a multi-functional memory I/O pin pair having functionality of a high-speed differential transmitter; and

FIG. 3c illustrates an exemplary embodiment of a multi-functional memory I/O pin pair having functionality of a high-speed differential receiver.

The detailed description explains the exemplary embodiments, together with advantages and features, by way of example with reference to the drawings.

### DETAILED DESCRIPTION OF EXEMPLARY EMBODIMENTS

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

One example of an integrated circuit according to the invention to be described with reference to the drawings is an integrated circuit for a memory input/output (I/O) pin having four different modes of operation. The memory chip is enabled to operate with unbuffered (or registered) dual inline memory modules (DIMMs) as well as fully buffered DIMMs. An exemplary embodiment of the invention provides a memory chip containing a multi-functional physical I/O circuit that can act as power or ground; as a DDR2 or DDR3 interface; as a high-speed differential receiver; or as a high-speed differential transmitter.

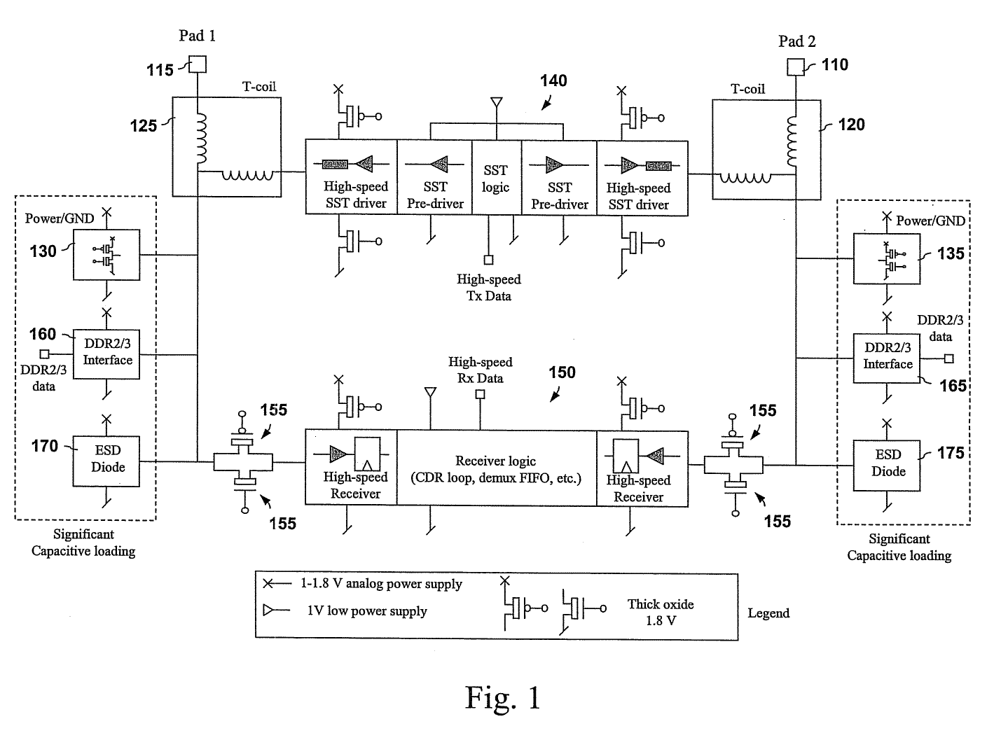

FIG. 1 illustrates an exemplary embodiment, wherein dual multi-functional memory pin I/O circuits provides power or ground 130, 135; a bi-directional DDR2 or DDR3 interface 160, 165; and/or a bi-directional high-speed transmitter or receiver 140, 150. Typically, the low-speed DDR2/DDR3 functions, as well as, the power/ground functions add a significant amount of parasitic capacitance to the input node. This prevents the high-speed operation of the differential fully buffered I/O's required for the high-speed differential receiver/transmitter operations. Furthermore, the DDR2/DDR3 interfaces 160, 165 may have voltages up to 1.8V, while high-speed differential receiver/transmitter I/O circuits 140, 150 may require less than 1V for minimum power consumption or because of constraints of the used semiconductor technology. These differences present an obstacle for providing multi-functional memory I/O operations on the same physical pin.

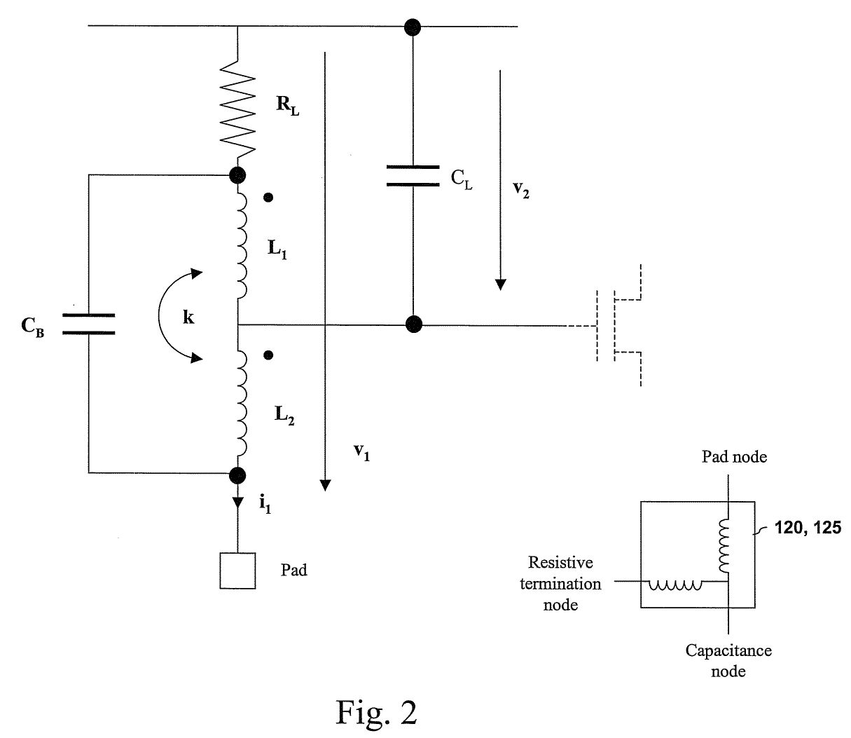

As shown in FIGS. 1 and 2, the T-coil is positioned at the input node of pads 110 and 115. FIG. 2 illustrates an exemplary embodiment of the T-Coil structure. FIG. 1 illustrates a schematic representation of an exemplary embodiment of the T-Coil structure. In order to compensate for the parasitic capacitances at the input node, a T-Coil circuit 120, 125 is introduced as shown in FIG. 1. The T-coil circuits 120, 125 are optimally used where the capacitive and resistive nodes can be separated. As shown in FIG. 2 the T-coil comprises coupled inductors L₁ and L₂ with coupling factor k as well as a bridge capacitor C_{B}. Inductor L₁ is connected between resistor R_{L} and the middle tap of the T-coil. Inductor L₂ is connected between the middle tap and the pad (or pin-out) node. A bridging capacitor C_{B} is connected between the opposite ends of inductors L₁ and L₂. The bridging capacitor allows high frequency energy to flow between the high-speed SST differential driver logic 140 and the pad node while the inductors are charging. The T-coil is optimally used in cases where the capacitive and resistive nodes are separated. In this embodiment the power/ground 130, 135; DDR2/3 interfaces 160, 165; and the electro static discharge (ESD) diodes 170, 175 produce significant capacitive loading. The resistive load includes resistor R_{L} and Capacitor C_{L} and connects to the high-speed SST differential driver logic 140 as illustrated in FIGS. 1 and 2. Note the thick oxide MOSFET devices used in the power/ground 130, 135 are used as switches rather than amplifiers. The node for resistive termination is connected to the high-speed SST differential driver logic 140. The Functionality of a T-coil is discussed for example in: L. Selmi et.al. “Small-Signal MMIC Amplifiers with Bridged T-Coil Matching Networks”, IEEE Journal of Solid-State Circuits, vol. 27, no. 7, p. 1093, July 1992.

In the exemplary embodiment the input return loss is small, while the transmission for the input pad to the capacitive pad also has low loss. FIG. 2 illustrates a T-coil circuit's properties. Here, it is shown that one could choose L₁, L₂, k, C_{B} such that:

Zᵢₙ(f)=dv₁/di₁=R_{L}

As can be seen from this formula the input impedance Zᵢₙ equals the resistive load and is independent of frequency. The transfer impedance has two complex poles:

$$\frac{{v}_{2}}{{i}_{1}} = \frac{{R}_{L} {ω}_{0}^{2}}{{s}^{2} + 2 ξ {ω}_{0} s + {ω}_{0}^{2}}$$

Here the transfer bandwidth is maximized with ζ=1/\sqrt{2}. Therefore, the L₁, L₂, k and C_{B} can be calculated by:

$${L}_{1 , 2} = \frac{{R}_{L}^{2} {C}_{L}}{4} [ 1 + \frac{1}{4 {ζ}^{2}} ] , \\ k = \frac{4 {ζ}^{2} - 1}{4 {ζ}^{2} + 1} , \\ {C}_{B} = \frac{{C}_{L}}{16 {ζ}^{2}} .$$

A key functionality of the circuit illustrated in FIG. 1 is that the circuit designer can select whether to use the pins 115, 110 as power or ground; or not use the pins 115, 110 at all (not connected). The pins 115, 110 can also be used as DDR2 or DDR3 interfaces. Pin 110 functions independently of pin 115 in the low-speed modes. Therefore, it is possible to have any of the not connected, power, ground, DDR2 or DDR3 interfaces on pin 110 while having any of the not connected, power, ground, DDR2 or DDR3 interfaces on pin 115.

High-speed operations are different, however. Pins 110 and 115 can also be used as a high-speed differential driver (transmitter) while switches above and below driver section are closed and all other switches are open. Alternatively, pins 110 and 115 can be used as high-speed differential receiver, wherein switches above and in front of the receiver are closed and switches above and below the driver closed, while all other switches remain open. Therefore, in this mode, the transmitter circuit acts as termination impedance for the receiver. In the high-speed modes, the T-coil is used to tune the parasitic capacitances that come from the disabled low-speed circuits, thus allowing high-frequency operation despite the fact that low-speed circuits are attached to the critical nodes, such as pins 110 and 115.

In an exemplary embodiment, the multi-functional memory I/O pin effectively allows the memory device to have at least five modes of operation. Mode 1 is a high-impedance or not connected state. This occurs when all switches are set to open and the DDR interface is set to a high-impedance state. Mode 2 is a power or ground state. The respective switches in the power or ground pin block are closed. Mode 3 provides a DDR 2 or DDR 3 memory interface state. In this state, all switches are open and the DDR interface block is operational. Mode 4 operates as a high-speed differential driver state. In this implementation, all switches related to the power/ground 130, 135; DDR 2/3 interface 160, 165; and high-speed receiver logic 150 are closed. All switches to the high-speed SST logic 140 are open. Finally, Mode 5 operates as a high-speed differential receiver state. In this state all switches to the high-speed SST logic 140 are closed such that the high-speed SST logic 140 acts as termination impedance for the high-speed receiver logic 150. All switches related to the power/ground 130, 135 and DDR 2/3 interface 160, 165 are also closed.

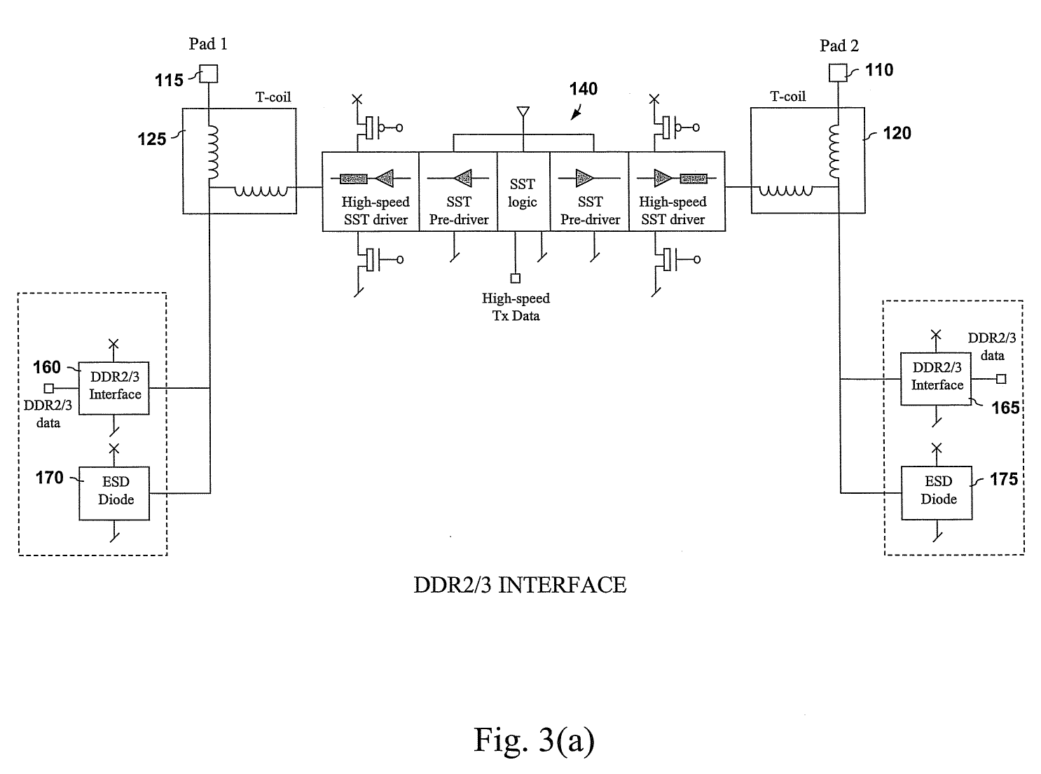

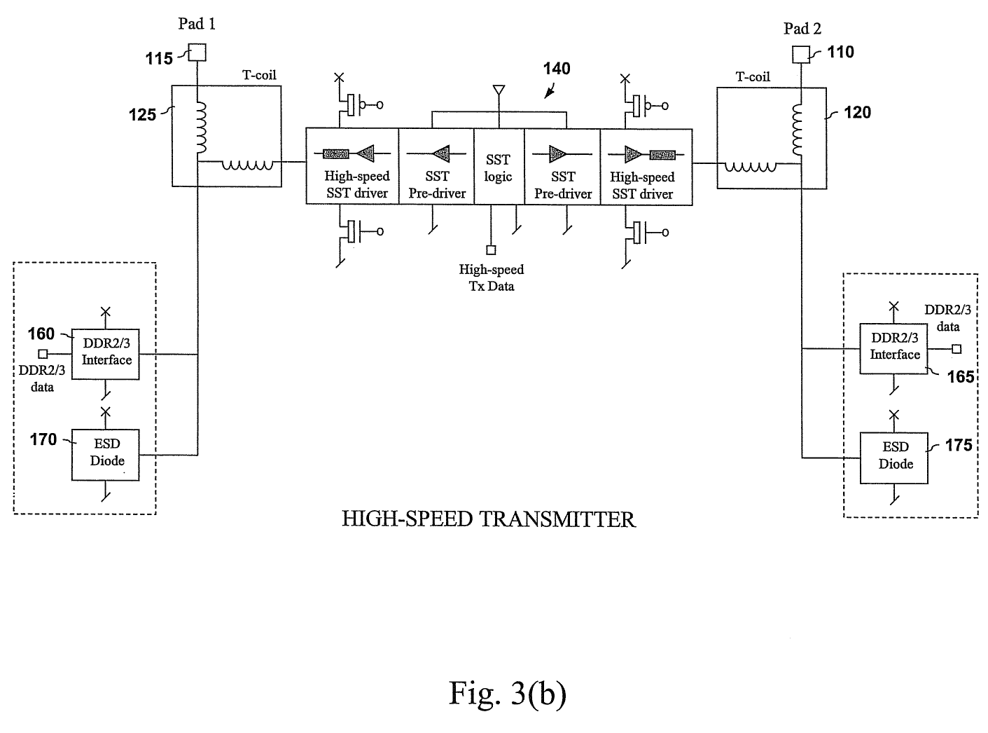

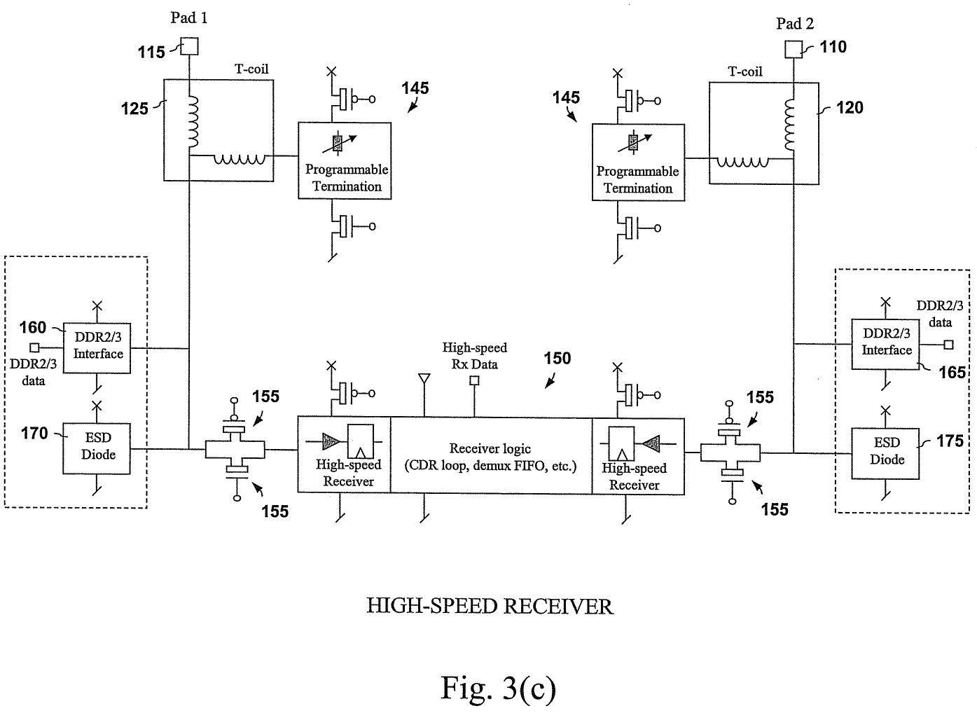

In an exemplary embodiment (FIG. 3a), when the multi-functional memory I/O pins are set to provide DDR2 or DDR3 memory interface states (mode 3), the high-speed SST logic 140 (Driver/Transmitter) and the high-speed receiver logic 150 are disconnected from the circuit. Therefore, from the T-coil, only one branch is active, the power/ground 130, 135; DDR 2/3 interface 160, 165; and the ESD diodes 170, 175. The MOSFET switches in the power/ground 130, 135 are turned off, leaving the DDR2/3 160, 165 and the ESD diodes 170, 175 active. The ESD diodes protect the circuit from electro-static discharge. The T-coil enables additional capacitive loading to allow multi-functionality of the circuit. All low-speed parasitic capacitances (including ESD) are bundled at the middle T-coil node. The DDR2 and DDR3 memory interface is enabled to allow bi-directional single-ended operation.

In still another exemplary embodiment (FIG. 3b), the two multi-functional memory I/O pins 110, 115 are combined to provide a high-speed differential transmitter state (mode 4). In this state the high-speed receiver logic is disconnected from the circuit, by switching off the MOSFETs 155 leading the circuit. Here, from the T-coil, all branches are active, however, switches to the power/ground 130, 135 and DDR2/DDR3 interfaces 160, 165 are turned off. The ESD diodes 170, 175 are active and protect the circuit from electro-static discharge. The T-coil enables additional capacitive loading to allow multi-functionality of the circuit. All low-speed parasitic capacitances (including ESD) are bundled at the middle T-coil node.

In another exemplary embodiment (FIG. 3c), the two multi-functional memory I/O pins 110, 115 are combined to provide a high-speed differential receiver state (mode 5). In this state the high-speed transmitter logic 140 is used to properly terminate the T-coil network acting as programmable termination 145. The T-coil circuit operates in standard configuration. The middle node of the T-coil is connected to the high-speed differential receiver logic 150, the DDR2 and DDR3 interfaces 160, 165 and the ESD diode protection circuit 170, 175. The T-coil enables additional capacitive loading to allow multi-functionality of the circuit. All low-speed parasitic capacitances (including ESD) are bundled at the middle T-coil node.

Therefore, in the exemplary embodiment, one pin pair allows several modes of operation in the memory device. The pin pair allows power/ground input, DDR2/3 interfaces and high-speed transmission or reception. Capacitive loading of high-speed nodes by low-speed functions is equalized by the T-coil circuit. Power minimization is also possible by enabling the use of low-voltage devices in high-speed modes of operation.

The capabilities of the present invention can be implemented in software, firmware, hardware or some combination thereof.

As one example, one or more aspects of the present invention can be included in an article of manufacture (e.g., one or more computer products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The illustrations depicted herein are just examples. There may be many variations to these circuit diagrams or operations described therein without departing from the spirit of the invention. For instance, the operations may be performed in a differing order, or steps may be added, deleted or modified. All of these variations are considered a part of the claimed invention.

While the exemplary embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. An integrated circuit having one or multiple modes of operation, the integrated circuit comprising:
a pair of terminal input/output pins;
a pair of T-coil circuits, wherein each pin is connected to a node of an individual T-coil circuit, wherein the individual T-coil circuit comprises a pair of serially connected inductors and a bridging capacitor forming three nodes, wherein at least one node is connected to the terminal input/output pin, a middle tap connected to a capacitive load, and a third node connected to a resistive load;
said capacitive load comprising an electrostatic discharge diode and a plurality of thick-oxide switches connecting at least one of a power or ground; a DDR2/DDR3 (double data rate two or three) interface; and a high-speed differential receiver circuit; and
said resistive load comprising a plurality of thick-oxide switches connecting a high-speed differential driver, wherein the plurality of thick-oxide switches are used to select the mode of operation of the integrated circuit, and wherein the T-coil circuit is used to compensate for parasitic capacitances.

2. An integrated circuit according to claim 1, wherein the integrated circuit functions in a power or ground mode when the thick-oxide switches connected to the power or ground are closed, and
wherein the integrated circuit functions in a non-connected or high-impedance mode when all of the thick-oxide switches are open and the DDR2/DDR3 interface is in a high-impedance state.

3. An integrated circuit according to claim 2, wherein the integrated circuit functions in a DDR2/DDR3 interface mode when all of the thick-oxide switches are open.

4. An integrated circuit according to claim 1, wherein the integrated circuit functions as a high-speed differential driver when all thick oxide switches above and below the high-speed differential driver section are closed and all other thick oxide switches are open.

5. An integrated circuit according to claim 1, wherein the integrated circuit functions as a high-speed differential receiver when all thick oxide switches above and below the high-speed differential driver section are closed, all thick oxide switches above and in front of the high-speed differential receiver are closed, and all other thick oxide switches are open.

6. A system for an integrated circuit having one or multiple modes of operation, the integrated circuit comprising:
a pair of terminal input/output pins;
a pair of T-coil circuits, wherein each pin connects to a node of an individual T-coil circuit, wherein the individual T-coil circuits comprise a pair of serially connected coupled inductors and a bridging capacitor forming three nodes, wherein at least one node is connected to the terminal input/output pin, a middle tap connected to a capacitive load, and a third node connected to a resistive load;
the capacitive load comprising an electrostatic discharge diode and a plurality of thick-oxide switches connecting at least one of a power or ground; a DDR2/DDR3 interface; and a high-speed differential receiver circuit;
the resistive load comprising a plurality of thick-oxide switches connecting a high-speed differential driver, wherein the plurality of thick-oxide switches are used to select the mode of operation of the integrated circuit, and wherein the T-coil circuit is used to compensate parasitic capacitances.
